(19) United States
(12) Patent Application Publication
(10) Pub. No.: US 2022/0023132 A1
(43) Pub. Date: Jan. 27, 2022

(54) BENDING AND STRETCHING MOTION ASSIST DEVICE

(71) Applicant: HONDA MOTOR CO., LTD., Minato-ku, Tokyo (JP)

(72) Inventors: Kenichi KATAGIRI, Saitama (JP); Toru TAKENAKA, Saitama (JP); Tomoko OTANI, Saitama (JP)

(21) Appl. No.: 17/311,747

(22) PCT Filed: Aug. 21, 2019
(86) PCT No.: PCT/JP2019/032589

§ 371 Date: Jun. 8, 2021

(51) Int. Cl. A61H 1/02; B25J 11/00

(52) U.S. Cl. CPC A61H 1/0255; B25J 11/00; A61H 2201/165; A61H 2201/163; A61H 2201/1642

(57) ABSTRACT

A bending and stretching motion assist device includes: left and right thigh links; left and right lower leg links swingably coupled to lower ends of the thigh links; a torso mount member having an annular shape and supporting upper ends of the left and right thigh links swingably on respective sides of left and right hip joints; left and right lower leg mount members respectively attached to lower ends of the left and right lower leg links; an assist force generation device configured to generate assist force in a stretching direction between the lower leg links and the thigh links to assist bending and stretching motion of lower limbs; and a buttocks support member extending between parts of the torso mount member adjacent to connecting parts that connect the torso mount member to the left and right thigh links, respectively, and including a buttocks pad.

### TECHNICAL FIELD

The present disclosure relates to a bending and stretching motion assist device configured to assist bending and stretching motion of the left and right lower limbs of a person.

### BACKGROUND ART

A variety of motion assist devices are proposed to assist motion of elderly persons or the like. For example, Patent Document 1 proposes a waist burden reduction device for assisting forward bending of the upper body, which includes a back frame, left and right shoulder bands extending from an upper portion of the back frame, left and right tensile force transmission strings, a coupling and mounting mechanism between the back frame and each of the left and right tensile force transmission strings, and left and right lower limb braces.

Also, Patent Document 2 proposes equipment for assisting reciprocal gait of a person with paralyzed lower limbs, in which left and right bars for supporting femoral parts and lower leg parts are pivoted on a pelvis and trunk support via hip joint coupling axes provided on left and right sides such that left and right bars can swing in the fore and aft direction, and each bar has a sole part attached to the lower end thereof for holding a foot of the person wearing the equipment. This equipment is provided with bar length varying mechanisms for changing the thicknesses of the respective sole parts and the heights of the respective heels by air pressure control, and alternately expands and contracts the lengths of the lengths of the left and right bars according to the walking motion.

### PRIOR ART DOCUMENT(S)

### Patent Document(s)

Patent Document 1: JP2015-163180A
Patent Document 2: JP3032086B2

### SUMMARY OF THE INVENTION

### Task to be Accomplished by the Invention

However, the motion assist device described in Patent Document 1 needs to be worn on the trunk (upper body) of the user by means of the left and right shoulder bands, and while it can assist forward bending of the upper body, it may limit the movable range of the upper body.

Also, though the motion assist device described in Patent Document 2 can assist walking, which is motion for movement in the horizontal direction, it cannot assist motion involving vertical movement of the upper body such as forward bending of the upper body or taking a half-rising posture or squatting posture. Therefore, it cannot assist such motion as that performed during work in a factory, for example, in which most of the motion is vertical movement at one position, and there is room for improving the efficiency of the motion assist function.

In view of such background, an object of the present invention is to provide a bending and stretching motion assist device that can be worn on the lower body so as not to limit the movable range of the upper body and also can efficiently assist bending and stretching motion that involves vertical movement of the upper body.

### Means to Accomplish the Task

To achieve such an object, a bending and stretching motion assist device (1) according to one embodiment of the present invention comprises: left and right thigh links (22) configured to be respectively disposed along left and right thighs of a user (P); left and right lower leg links (23) configured to be respectively disposed along left and right lower legs of the user and swingably coupled to lower ends of the corresponding thigh links; a torso mount member (2) having an annular shape to be able to be worn on a torso of the user and to support upper ends (25) of the left and right thigh links swingably on respective sides of left and right hip joints of the user; left and right lower leg mount members (28) respectively attached to lower ends of the left and right lower leg links so as to be able to be worn on the corresponding lower legs of the user; an assist force generation device (30, 40) configured to generate assist force in a stretching direction between the lower leg links and the thigh links to assist bending and stretching motion of lower limbs of the user; and a buttocks support member (10) extending between parts (5) of the torso mount member adjacent to connecting parts (25Xa) of the torso mount member that connect the torso mount member to the left and right thigh links, respectively, or between parts (24a) of the left and right thigh links adjacent to connecting parts of the left and right thigh links that connect the left and right thigh links to the torso mount member, respectively, thereby configured to be disposed along buttocks of the user.

According to this configuration, the bending motion of the lower limbs of the user is transmitted to the upper ends of the left and right thigh links via the buttocks support member, and the thigh links can be bent relative to the lower leg links. Also, in the state in which the lower limbs of the user are bent, the assist force generated by the assist force generation device according to the swing angle of the thigh links relative to the lower leg links is transmitted to the buttocks of the user via the buttocks support member to push up the buttocks from below, whereby the bending and stretching motion of the user can be favorably assisted. Also, the motion assist device does not limit the movable range of the upper body of the user.

In the above configuration, preferably, the torso mount member (2) includes an annular torso belt (3) configured to be worn on the torso of the user (P), and left and right link support members (4) provided to depend from left and right side portions of the torso belt and supporting the upper ends (25) of the left and right thigh links (22).

According to this configuration, because the torso mount member is constituted of the torso belt, the torso mount member can have a simple and lightweight configuration and the weight of the bending and stretching motion assist device can be reduced. Also, since the buttocks support member transmits the load of the upper body of the user to the thigh links, it is possible to provide the left and right link support members to depend from the side portions of the torso belt, and this also contributes to allowing the torso mount member to have a simple and lightweight configuration.

In the above configuration, preferably, each link support member (4) includes a support plate (5) having high stiffness and swingably supporting the upper end (25) of the thigh link (22) on a corresponding side and a flexible belt member (6, 7, 56) coupling the support plate to the torso belt.

According to this configuration, the left and right support plates are not rigidly joined to each other, and the buttocks support member extending between the left and right support plates supports the buttocks like a hammock, whereby a pressure making the left and right support plates closely contact the torso side portions (hip side portions) is generated according to the force supporting the buttocks. Namely, the pressure is always adjusted to an appropriate pressure that prevents positional shift of the support plates, and therefore, fitting property is improved. Also, when the buttocks support member is not generating the force supporting the buttocks, unnecessary pressure is not generated between each support plate and the torso side portion (hip side portion). Further, it is possible to reduce the size of the support plate which has high stiffness and supports the upper end of the thigh link, to thereby reduce the weight of the link support member.

In the above configuration, preferably, the belt member includes a front suspension belt (6) extending obliquely forward and upward from a front portion of the support plate (5) and joined to the torso belt (3) and a rear suspension belt (7) extending obliquely rearward and upward from a rear portion of the support plate and joined to the torso belt.

According to this configuration, since the support plate is joined to the torso belt by the front suspension belt and the rear suspension belt, the support plate can be joined to the torso belt so as not to move in the fore and aft direction.

In the above configuration, preferably, each end portion of the buttocks support member (10) is coupled to the support plate (5) on an extension line of the front suspension belt (6).

According to this configuration, part of the load of the buttocks supported by the buttocks support member is linearly transmitted to the torso belt via the front suspension belt. Therefore, the support plate is prevented from easily shifting from an appropriate position.

In the above configuration, preferably, the belt member (56) is provided to be slidable relative to the torso belt (3) in a circumferential direction.

According to this configuration, the position of the support plate in the circumferential direction can be changed easily.

In the above configuration, preferably, each link support member (4) includes a substantially inverted-triangular flexible member (61) having flexibility and depending from a side portion of the torso belt (3) and a joint member (62) provided adjacent to a lower end of the flexible member and swingably supporting the upper end of the thigh link (22) on a corresponding side.

According to this configuration, the load of the link support member can be transmitted to a circumferentially elongated part of the torso belt in a dispersed manner. Therefore, the weight of the bending and stretching motion assist device felt by the user when wearing the device is reduced.

In the above configuration, preferably, the torso belt (3) is provided with a front length adjustment mechanism (53) and a rear length adjustment mechanism (51a) capable of adjusting lengths of a front part and a rear part between the left and right link support members (4).

According to this configuration, even when the torso mount member is worn on the torso of the user, the positions of the left and right link support members in the circumferential direction can be adjusted by adjusting the length of the torso belt with the front length adjustment mechanism and the rear length adjustment mechanism. Therefore, it is possible to provide a bending and stretching motion assist device with excellent fitting property which can be suited to the physique of the user.

In the above configuration, preferably, each end portion of the buttocks support member (10) is joined to the link support member (4), and the bending and stretching motion assist device further comprises left and right thigh belts (15) which are annular in shape to be worn on the left and right thighs of the user (P), respectively, and are coupled to the buttocks support member.

According to this configuration, the thigh belts prevent the buttocks support member from shifting upward relative to the buttocks.

In the above configuration, preferably, the left and right thigh belts (15) are each provided in a non-coupled manner with the thigh link (22) on a corresponding side.

According to this configuration, it is possible to prevent positional shift of the buttocks support member due to movement of the thigh belts in response to motion of the thigh links.

In the above configuration, preferably, each end portion of the buttocks support member (10) is coupled to a part (24a) of the thigh link (22) which is closer to the lower leg link (23) than the connecting part (25Xa) with the torso mount member (2) is.

According to this configuration, when the lower portions of the thigh links move forward as a result of bending of the lower limbs, the end portions of the buttocks support member are pulled forward by the thigh links, whereby the buttocks support member remains below the buttocks and reliably supports the load of the buttocks.

In the above configuration, preferably, the bending and stretching motion assist device (1) further comprises left and right knee mount members (27) provided on lower portions of the left and right thigh links (22) or upper portions of the lower leg links (23) to be worn on parts of the user (P) adjacent to knee joints of the left and right lower limbs, respectively.

According to this configuration, the lower portions of the thigh links and the upper portions of the lower leg links are held adjacent to the knee joints of the lower limbs by the knee mount members, so that the lower leg links and the thigh links are prevented from departing from the lower limbs when the knees are bent.

In the above configuration, preferably, the buttocks support member (10) includes a buttocks pad (12) positioned lower than the upper ends (25) of the thigh links (22) in a bent state of the lower limbs of the user (P).

According to this configuration, in the state in which the lower limbs are bent, the assist force generated by the assist force generation device is efficiently transmitted to the buttocks via the buttocks pad to push up the buttocks from below, whereby the bending and stretching motion of the user can be favorably assisted.

In the above configuration, preferably, the buttocks pad (12) is provided at a laterally central portion thereof with a low stiffness part (12a) having a torsional stiffness lower than that of left and right side portions.

According to this configuration, in response to twisting of the buttocks that accompanies the motion of the lower limbs, the buttocks pad also undergoes torsional deformation and favorably prevents positional shift of the buttocks pad relative to the buttocks.

In the above configuration, preferably, the buttocks pad (12) has a narrow part (13, 14) at a laterally central portion thereof.

According to this configuration, it is possible to form the low stiffness part by the shape of the narrow part without varying the thickness of the material or using materials with different bending strengths in combination, which allows easy manufacture of the buttocks pad having the low stiffness part.

In the above configuration, preferably, the left and right thigh links (22) are each detachably coupled to the torso mount member (2) via an attachment and detachment mechanism (21).

According to this configuration, the left and right leg link mechanisms constituted of the left and right thigh links and the left and right lower leg links, respectively, can be removed from and attached to the torso mount member with the torso mount member being worn on the torso of the user. This facilitates wearing and removal of the bending and stretching motion assist device (ease of wearing improves). In addition, since attachment and detachment of only the leg link mechanisms is possible, whereby the usability of the bending and stretching motion assist device improves.

In the above configuration, preferably, the assist force generation device (30, 40) includes a flexible elongated member (41), left and right cam members (26) configured to change a route of the elongated member such that a route length becomes longer as a total value of swing angles of the left and right thigh links (22) relative to the left and right lower leg links (23) increases, and a spring member (30) configured to expand and contract in response to a change in the route length of the elongated member.

According to this configuration, the assist force generation device can be realized with a simple and lightweight configuration. This can reduce the weight of the bending and stretching motion assist device.

### Effect of the Invention

Thus, according to the present invention, a bending and stretching motion assist device can be provided.

### BRIEF DESCRIPTION OF THE DRAWINGS

FIG. 1 is a perspective view of a bending and stretching motion assist device according to the first embodiment;

FIG. 2 is a front view of the bending and stretching motion assist device shown in FIG. 1;

FIG. 3 is a side view of the bending and stretching motion assist device shown in FIG. 1;

FIG. 4 is a perspective view around the torso mount member shown in FIG. 1;

FIG. 5 is a front view around the torso mount member shown in FIG. 1;

FIG. 6 is a side view around the torso mount member shown in FIG. 1;

FIG. 7 is an operation explanatory diagram of the bending and stretching motion assist device shown in FIG. 1;

FIG. 8 is an operation explanatory diagram of the bending and stretching motion assist device shown in FIG. 1;

FIG. 9 is a side view of a main part of a bending and stretching motion assist device according to the second embodiment;

FIG. 10 is an operation explanatory diagram of the bending and stretching motion assist device shown in FIG. 8;

FIG. 11 is a front view around the torso mount member of a bending and stretching motion assist device according to the third embodiment;

FIG. 12 is a rear view around the torso mount member shown in FIG. 11;

FIG. 13 is a side view around the torso mount member shown in FIG. 11; and

FIG. 14 is a side view around the torso mount member of a bending and stretching motion assist device according to the fourth embodiment.

### MODES(S) FOR CARRYING OUT THE INVENTION

In the following, embodiments of the present invention will be described in detail with reference to the drawings.

### First Embodiment

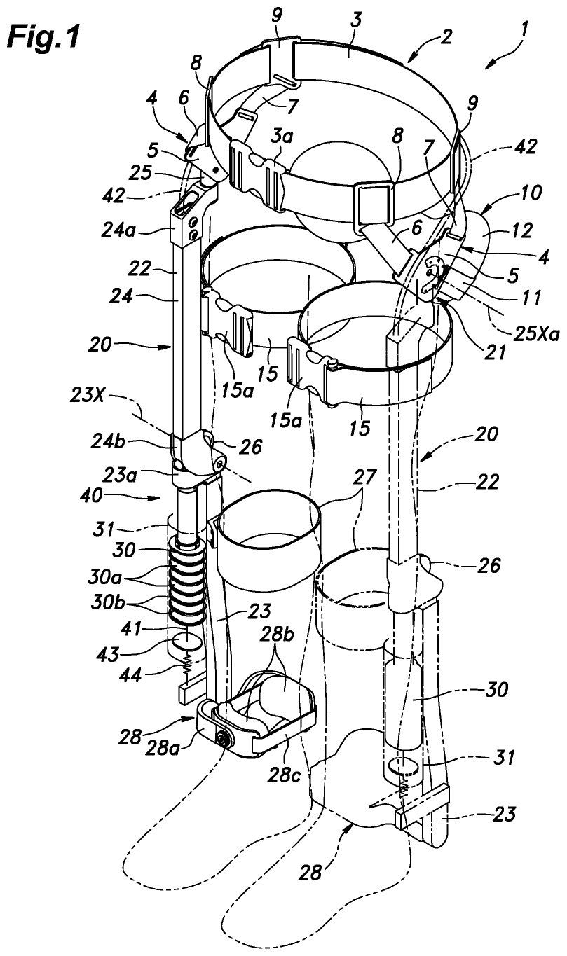

First, with reference to FIGS. 1 to 8, the first embodiment of the present invention will be described. A bending and stretching motion assist device 1 shown in FIGS. 1 to 3 is a device to be worn on a lower body of a user P to assist the bending and stretching motion of the left and right lower limbs (legs).

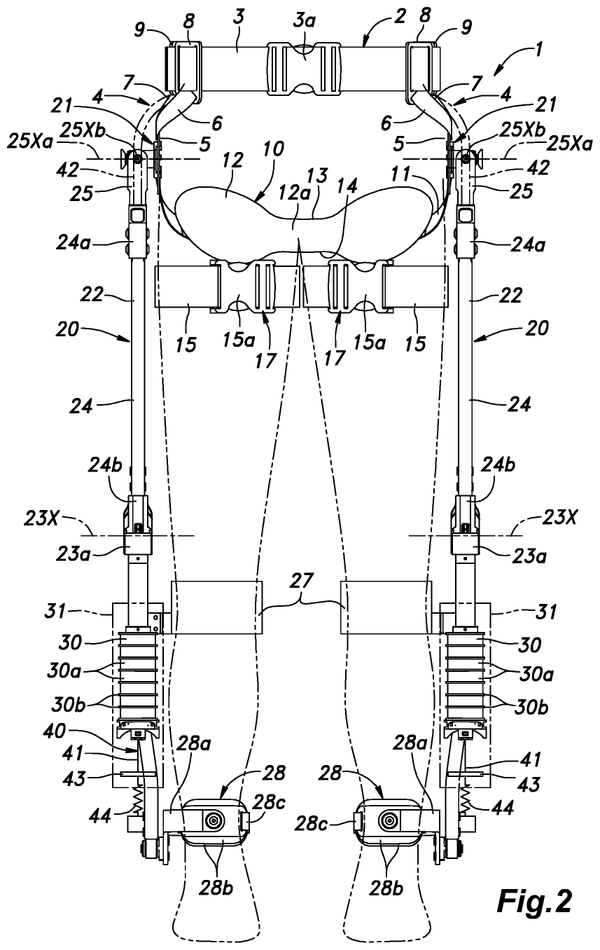

The bending and stretching motion assist device 1 is provided with a torso mount member 2 configured to be worn on the torso of the user P, a buttocks support member 10 configured to be worn on the buttocks of the user P to support the buttocks, left and right leg link mechanisms 20 provided to extend from left and right side portions of the torso mount member 2 to serve as equipment to be worn on the left and right legs of the user P, left and right spring members 30 (shown in FIG. 2) that can generate an elastic force for assisting the motion of the respective legs of the user P, and a motion transmission mechanism 40 configured to transmit bending and stretching motion of the legs (bending and stretching motion of the hip joints) of the user P to the left and right spring members 30 so that the spring members 30 can generate the elastic force in response to bending of the leg(s) (one leg or the both legs) of the user P.

In the present embodiment, the torso mount member 2 is configured to be worn on a part of the torso of the user P, for example, a waist (a part corresponding to the height of the lumbar vertebrae, such as a pelvis upper portion or the small of the back). The torso mount member 2 includes an annular torso belt 3 equipped with a buckle 3a to be disposed in front of the abdomen of the user P, and is configured to be worn on the waist with the torso belt 3 wrapped around the waist of the user P.

Further, the torso mount member 2 includes left and right link support members 4 provided on the torso belt 3 so as to be suspended from left and right side portions of the torso belt 3 to swingably support the upper ends of the left and right leg link mechanisms 20 on the lateral sides of the left and right hip joints of the user P, respectively. Each link support member 4 is formed of a support plate 5 having high stiffness and swingably supporting the upper end of the leg link mechanism 20 on the corresponding side, a front suspension belt 6 which extends obliquely forward and upward from a front portion of the support plate 5 and is joined to the torso belt 3, and a rear suspension belt 7 which extends obliquely rearward and upward from a rear portion of the support plate 5 and is joined to the torso belt 3. The belt main body of the torso belt 3, the front suspension belt 6, and the rear suspension belt 7 is made of fabric, leather, artificial leather, etc., for example, and has flexibility.

Each support plate 5 has a substantially pentagonal shape and is coupled to the torso belt 3 via the front suspension belt 6 and the rear suspension belt 7 such that in a state where the torso belt 3 is worn on the waist of the user P, the support plates 5 respectively oppose the left and right sides of the waist at a height substantially the same as that of the left and right hip joints of the user P. The front suspension belt 6 extends obliquely forward and upward from the front upper portion of the support plate 5 and is coupled to the front portion of the torso belt 3 via a front mounting bracket 8. The rear suspension belt 7 extends obliquely rearward and upward from the rear upper portion of the support plate 5 and is coupled to the rear portion of the torso belt 3 via a rear mounting bracket 9. The front suspension belt 6 and the rear suspension belt 7 couple the torso belt 3 and the support plate 5 to each other in a length adjustable manner, whereby irrespective of the mounting position of the torso belt 3 on the torso, the position of the support plate 5 can be adjusted.

Note that the torso mount member 2 may be configured to be worn on the torso at a position higher than the waist of the user P. The structure for mounting the torso mount member 2 on the torso of the user P may differ from the aforementioned structure so long as it can maintain the position of the torso mount member 2 relative to the torso substantially constant.

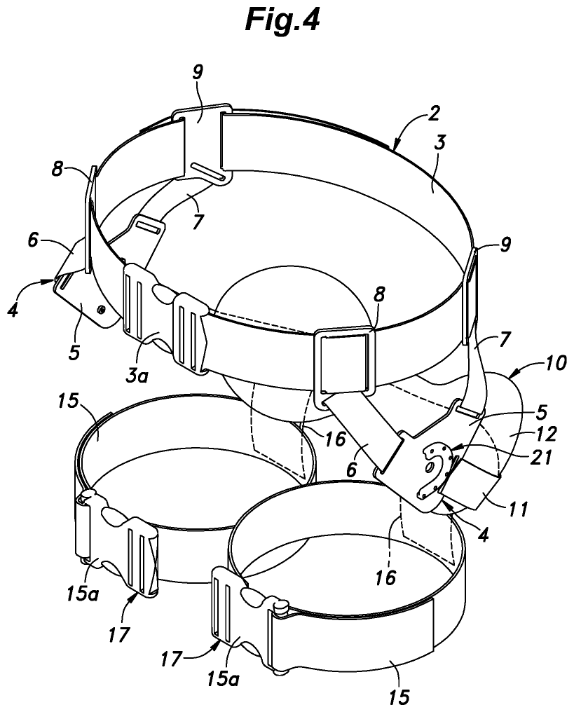

Next, with reference to FIGS. 4 to 6, the buttocks support member 10 will be described. As shown in FIGS. 4 to 6, the buttocks support member 10 includes a buttocks belt 11 provided integrally with the torso mount member 2 so as to extend between the left and right support plates 5, and a buttocks pad 12 mounted on the buttocks belt 11 to be disposed along the buttocks of the user P when the torso belt 3 is worn on the waist of the user P.

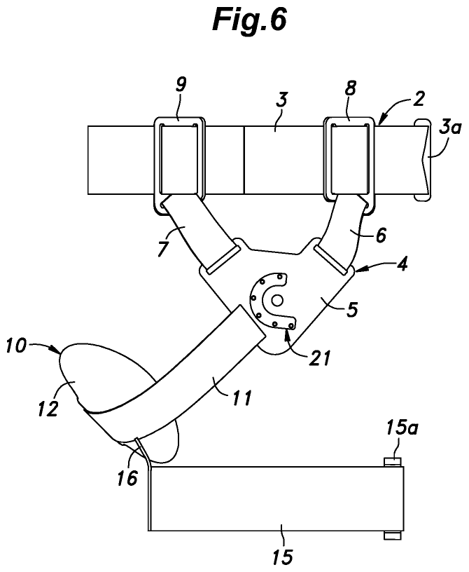

The buttocks belt 11 have both ends joined to rear portions of the left and right support plates 5, respectively, and in side view (FIG. 6), extends out obliquely rearward and downward from the left and right support plates 5 to extend laterally behind the lower portion of the buttocks of the user P. The both end portions of the buttocks belt 11 are respectively coupled to the support plates 5 on the extension lines of the front suspension belts 6 in side view (FIG. 6).

The buttocks pad 12 includes a skin member formed with holes through which the buttocks belt 11 is passed and a cushion member provided in the skin member, and has a bilaterally symmetric gourd-like shape elongated in the lateral direction. In other words, an upper side of the buttocks pad 12 is formed with an upper cutout 13 which is recessed downward, and a lower side of the buttocks pad 12 is formed with a lower cutout 14 which is recessed upward. Thereby, the laterally central portion of the buttocks pad 12 forms a narrow part having a small height dimension compared to the left and right side portions adjacent thereto on the left and right, and serves as a low stiffness part 12a having low torsional stiffness compared to the left and right side portions.

Left and right thigh belts 15 configured to be worn on the left and right thighs of the user P are coupled to the buttocks support member 10 via left and right coupling bands 16, respectively. Each thigh belt 15 has a buckle 15a to be positioned in front of the thigh, and the buckle 15a is provided with a length adjustment mechanism 17. The thigh belt 15 is worn on the thigh of the user P, with the strip-shaped belt member wound around the thigh and the both ends thereof coupled by the buckle 15a to form a ring. Each coupling band 16 is joined to the thigh belt 15 and supports the lower portion of the buttocks pad 12.

As shown in FIGS. 1 to 3, the left and right leg link mechanisms 20 are bilaterally symmetric to each other and have an identical structure. Each leg link mechanism 20 is detachably coupled to the support plate 5 of the torso mount member 2 on the corresponding side via an attachment and detachment mechanism 21 and includes one of left and right thigh links 22 configured to be disposed along the thigh of the user P on the corresponding side and a lower leg link 23 coupled to the lower end of the one of the left and right thigh links 22 to be disposed along the lower leg of the user P on the corresponding side.

Each thigh link 22 is configured to extend in the longitudinal direction of the thigh of the user P on a lateral side of the front portion of the thigh, and is provided with a link main body 24 having an upper end portion 24a and a lower end portion 24b each extending rearward. An upper coupling member 25, which is fixed to the support plate 5, is coupled to the rear portion of the upper end portion 24a of the link main body 24 so as to be rotatable about a swing axis 24X parallel to the longitudinal direction of the link main body 24. The upper coupling member 25 is coupled to the support plate 5 to be swingable about a swing axis 25Xa extending in the lateral direction and about a swing axis 25Xb extending in the fore and aft direction.

Each lower leg link 23 is configured to extend in the longitudinal direction of the lower leg of the user P on a lateral side of the lower leg, and is provided with an upper end portion 23a which extends forward. The rear portion of the upper end portion 23a of the lower leg link 23 is coupled to the rear portion of the lower end portion 24b of the thigh link 22 (link main body 24) so as to be swingable about a swing axis 23X extending in the lateral direction. The swing axis 23X of the lower leg link 23 is disposed on the side of the knee joint of the user P. The thigh link 22 may be configured to have a mechanism for enabling adjustment of the length such that the upper coupling member 25 of the thigh link 22 is disposed on the side of the hip joint of the user P and the swing axis 23X of the lower leg link 23 is disposed on the side of the knee joint of the user P.

The rear portion of the upper end portion 23a of each lower leg link 23 is provided with a pulley 26 to be rotatable about a rotation axis 26X extending in the lateral direction. The rotation axis 26X of the pulley 26 is positioned above and forward of the swing axis 23X of the lower leg link 23.

An annular knee belt 27 is attached to the upper portion of each lower leg link 23 so as to be worn on the upper portion of the lower leg of the user P on the corresponding side as a knee mount member. The knee belt 27 is provided with a length adjustment mechanism such as a hook-and-loop fastener, a buckle, and so on (not shown in the drawings), and is wound around the lower leg of the user P thereby to be worn on the lower leg and hold the lower leg link 23 in the vicinity of the lower leg of the user P. Note that the knee belt 27 is only required to be worn near the knee joint of the lower limb, and therefore, does not necessarily have to be attached to the lower leg link 23, and may be provided on the lower portion of the thigh link 22 or the upper portion of the lower leg link 23.

The above-described thigh belt 15 is worn on the thigh of the user P at a height corresponding to the thigh link 22, but is coupled to only the buttocks support member 10 by the coupling band 16 and is not coupled to the thigh link 22 (provided in a non-coupled manner with the thigh link 22).

The lower portion of each lower leg link 23 is provided with a lower leg mount member 28 to be worn on the lower portion (ankle) of the lower leg of the user P on the corresponding side. The lower leg mount member 28 includes a support arm 28a extending from the lateral side of the ankle of the user P to the front side and rear side of the ankle to have a U-shape in plan view, front and rear ankle pads 28b provided on the rear side of the front portion of the support arm 28a and the front side of the rear portion of the support arm 28a to contact the front and rear sides of the ankle, respectively, and a fixing belt 28c coupling the inner parts of the front and rear ankle pads 28b to each other and surrounding the ankle jointly with the support arm 28a and the ankle pads 28b thereby to fix the lower leg mount member 28 to the ankle.

Each leg link mechanism 20 is configured as described above. Therefore, with the torso belt 3 of the torso mount member 2 worn on the torso (waist) of the user P and the knee belt 27 and the lower leg mount member 28 of each leg link mechanism 20 worn on the lower leg of the user P, each leg link mechanism 20 is worn on the leg of the user P so as to move with the leg.

Specifically, in response to the swing of the thigh of each leg of the user P relative to the torso (swing in the pitch direction at the hip joint), the thigh link 22 of the leg link mechanism 20 on the same side as the leg swings relative to the torso mount member 2 about the swing axis 25Xa extending in the lateral direction. Thereby, the thigh link 22 moves with the thigh of the user P such that the positional relationship with the thigh is maintained substantially constant.

Also, in response to the swing of the lower leg of each leg of the user P relative to the thigh (swing in the pitch direction at the knee joint), the lower leg link 23 of the leg link mechanism 20 on the same side as the leg swings relative to the thigh link 22 about the swing axis 23X extending in the lateral direction. Thereby, the lower leg link 23 moves with the lower leg of the user P such that the positional relationship with the lower leg is maintained substantially constant.

At this time, the annular left and right knee belts 27 worn on the upper portions of the left and right lower legs of the user P hold the lower leg links 23 on the corresponding sides, and therefore, each leg link mechanism 20 constituted of the lower leg link 23 and the thigh link 22 is prevented from parting from the lower limb when the knee joint is bent.

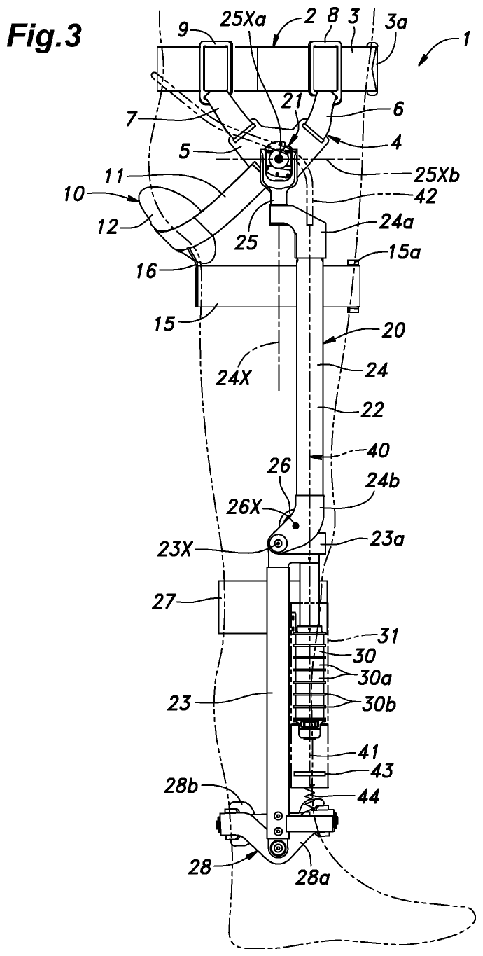

The left and right spring members 30 have the same specifications. In the present embodiment, as shown in FIG. 2 or FIG. 3, each spring member 30 is configured by alternately stacking multiple tubular elastic members 30a made of rubber or the like and multiple hard plates 30b made of metal or the like. The mutually contacting elastic member 30a and the plate 30b are bonded to each other by an adhesive or the like. At an axial center of the spring member 30, a through hole (not shown in the drawings) through which a wire 41 is passed is formed. Note that both end portions of the spring member 30 in the direction of the axial center are each formed of a plate 30b.

A guide tube 31 formed to be hollow to accommodate the spring member 30 therein is attached to the lower leg link 23 of each leg link mechanism 20. The guide tube 31 is disposed along the lower leg link 23 of each leg link mechanism 20 to extend in the longitudinal direction of the lower leg link 23, and the upper end thereof is fixed to the front portion of the upper end portion 23a of the lower leg link 23. As shown in FIGS. 1 to 3, in the standing state of the user P in which the knee joints are stretched, the spring member 30 and the guide tube 31 are disposed on the axis of the link main body 24 of the thigh link 22.

Each spring member 30 is accommodated in the guide tube 31 to be able to expanding and contracting in the direction of the axial center and is fixed to the upper end of the guide tube 31. The spring member 30 of the present embodiment generates an elastic force when in compressive deformation and causes the generated elastic force to act on the user P as assist force via the motion transmission mechanism 40. Note that the spring member 30 may be constituted of a coil spring, for example, so as to generate the elastic force due to expansion (tensile deformation) or compressive deformation of the coil spring.

As shown in FIGS. 1 to 3, in the present embodiment, the motion transmission mechanism 40 includes a wire 41 serving as a flexible elongated member coupled to the left and right spring members 30, an outer tube 42 covering a part of the wire 41 in a freely slidable manner, a pulley 26 installed in each of the leg link mechanisms 20, and an engagement member 43 disposed in each guide tube 31 below the spring member 30 to be slidable in the vertical direction.

The outer tube 42 is a tube having a prescribed length and is disposed to extend substantially in the lateral direction on the back side of the torso mount member 2. The left and right end portions of the outer tube 42 extend downward and are fixed to the front portions of the upper end portions 24a of the link main bodies 24 of the left and right thigh links 22, respectively.

The wire 41 is passed through the outer tube 42 freely slidably, and extends out from both ends of the outer tube 42. Each of the left and right extending-out portions of the wire 41 passes on the front side of the pulley 26 on the corresponding side through the axis (interior) of the link main body 24 of the thigh link 22 to reach the upper end of the guide tube 31, and further passes through a hole formed in the upper end of the guide tube 31 to be introduced into the guide tube 31. Then, the extending-out portion of the wire 41 introduced into the guide tube 31 passes through the through hole of the spring member 30 to be joined to the engagement member 43. As shown in FIGS. 1 to 3, in the standing state of the user P in which the knee joints are stretched, the mutual positional relationship between the spring member 30 and the engagement member 43 (length of the wire 41) is set such that a gap G having a prescribed value is formed between the lower end of the spring member 30 and the engagement member 43 as shown in FIG. 2.

The motion transmission mechanism 40 includes left and right slack eliminating spring members 44 (see FIG. 2) for applying relatively weak tension (pre-tension) to the wire 41 to eliminate slack in the wire 41. Each slack eliminating spring member 44 is a spring having a sufficiently smaller stiffness (so-called spring constant) than each spring member 30, and in the present embodiment, constituted of a coil spring, for example. Note that each slack eliminating spring member 44 may be constituted of a spring other than the coil spring; for example, a rubber member such as a rubber strap.

In the motion transmission mechanism 40, the lower end of each slack eliminating spring member 44 is fixed to the lower leg link 23, and the left and right extending-out portions of the wire 41 are respectively coupled to the slack eliminating spring members 44 below the engagement members 43. Each slack eliminating spring member 44 is coupled to the extending-out portion of the wire 41 to be capable of expanding and contracting according to the movement of the engagement member 43 in the guide tube 3.

Since the wire 41 passes the front side of each pulley 26 and the swing axis 23X of the lower leg link 23 relative to the thigh link 22 is located at a position spaced from the wire 41 rearward, the route length of the wire 41 from each of the left and right end portions of the outer tube 42 to the upper end of the guide tube 31 on the corresponding side monotonously increases with an increase in the bending degree of the leg (the bending degree of the knee joint) when the user P wearing the bending and stretching motion assist device 1 bends the leg from the stretched state. Namely, the left and right pulleys 26 function as left and right cam members configured to change the route of the wire 41 such that the route length becomes longer as the total value of the swing angles of the left and right thigh links 22 relative to the left and right lower leg links 23 increases.

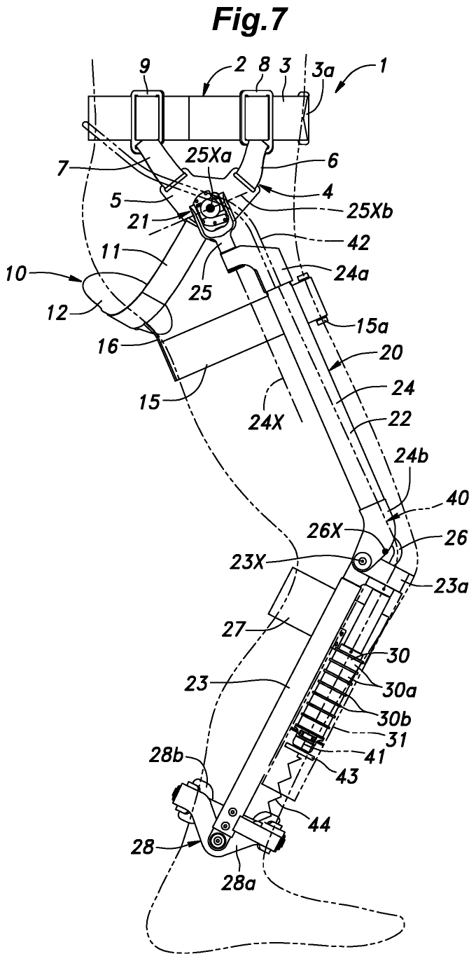

Therefore, when the user P wearing the bending and stretching motion assist device 1 bends the both legs by approximately the same bending degree from the state in which the both legs are stretched, the left and right engagement members 43 move upward in the guide tubes 31 with an increase in the bending degrees of the both legs, as shown in FIG. 7. Note that the motion involving bending of the both legs of the user P as this may be a motion performed when the user P sits on a chair or the like or squats in a Hindu squat motion or the like, for example.

As the bending degrees of the both legs of the user P increase, each of the engagement members 43 approaches the lower end of the spring member 30 while each slack eliminating spring member 44 expands. Under this circumstance, only the slack eliminating spring members 44, which have sufficiently small stiffness compared to that of each spring member 30, expand, and therefore, the tensile force of the wire 41 remains sufficiently small. Consequently, an assist force in the direction to stretch the both legs of the user P is substantially not generated.

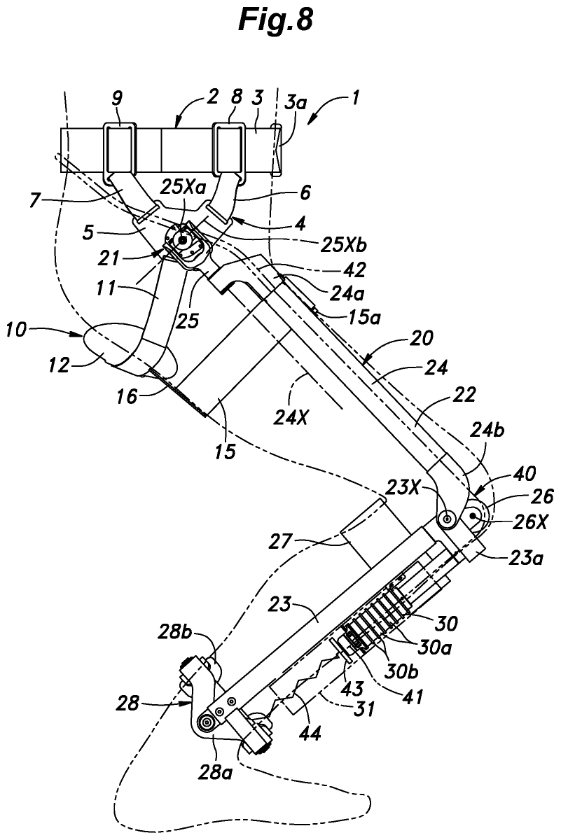

As the bending degrees of the both legs of the user P increase further, each of the engagement members 43 comes into contact with the lower end of the corresponding spring member 30 and is engaged by the same. As the bending degrees of the both legs of the user P increase further from this state, the route length of the wire 41 from each of the left and right end portions of the outer tube 42 to the upper end of each of the left and right guide tube 31 increases, and consequently the engagement member 43 causes the associated spring member 30 to undergo compressive deformation, as shown in FIG. 8. Thereby, each spring member 30 generates an elastic force in the stretching direction, and this elastic force acts on each leg link mechanism 20 via the motion transmission mechanism 40 as an assist torque in the stretching direction.

This assist torque acting on each leg link mechanism 20 in the stretching direction acts on the left and right ankles and the torso of the user P as an assist force that separates each of the left and right ankles from the torso of the user P (assists the stretching motion at the knee joint of each leg) via the lower leg mount member 28 and each of the link support members 4 of the torso mount member 2. In this way, each of the left and right spring members 30 and the motion transmission mechanism 40 constitute an assist force generation device for generating an assist force in the stretching direction between the lower leg link 23 and the thigh link 22 to assist the bending and stretching motion of the lower limb of the user P.

As shown in FIG. 8, in this bent state of the lower limbs of the user P, the buttocks pad 12 is positioned lower than the upper end of each thigh link 22. Therefore, the upward force transmitted from each link support member 4 of the torso mount member 2 to the torso of the user P is transmitted from the link support member 4 to the buttocks support member 10 and then from the buttocks pad 12 positioned below the buttocks to the buttocks of the user P.

Namely, the assist force is not transmitted from the torso belt 3 to the waist of the user P to lift up the waist, but is transmitted to the buttocks of the user P to push up the buttocks upward. Thereby, the bending and stretching motion of the user P is favorably assisted. Also, the movable range of the upper body of the user P is not limited.

This assist force supports the upper body load when the user P bends the left and right legs to squat and when the user P stretches the left and right legs to stand up. Namely, this assist force acts as an assist force assisting the bending and stretching motion of the user P. The elastic force of the spring members 30 and the tensile force of the wire 41 creating this assist force increase with a further increase in the bending degrees of the both legs of the user P.

As described above, when the both legs of the user P are bent, the elastic force of each spring member 30 is substantially not generated and the assist force substantially does not act on the both legs of the user P until the bending degrees of the both legs reach a prescribed bending degree (the bending degrees shown in FIG. 7 at which the both engagement members 43 come into contact with and are engaged by the lower ends of the respective guide tubes 31). Then, when the bending degrees of the both legs of the user P exceed the aforementioned prescribed bending degree, the elastic force of the spring member 30 is generated and the tensile force of the wire 41 increases, whereby an assist force in the stretching direction acts on the both legs of the user P.

On the other hand, when the user P wearing the bending and stretching motion assist device 1 bends one leg while maintaining the other leg in the stretched state (or a state close to this state), the wire 41 can move in the outer tube 42, and therefore, only the elastic force of the left and right slack eliminating spring members 44 acts on the wire 41 until both of the left and right engagement members 43 come into contact with the lower ends of the corresponding spring members 30.

Therefore, unless the bending angle of the one leg exceeds this angle, the elastic force of the spring member 30 is substantially not generated and the assist force substantially does not act on the leg of the user P. This angle is greater than the angle at which the assist force starts acting when the user P bends the both legs, and is about twice the angle. Therefore, the user P can perform a motion, such as walking, that involves bending of one leg, with a similar feeling as in usual motion without feeling discomfort due to the assist force.

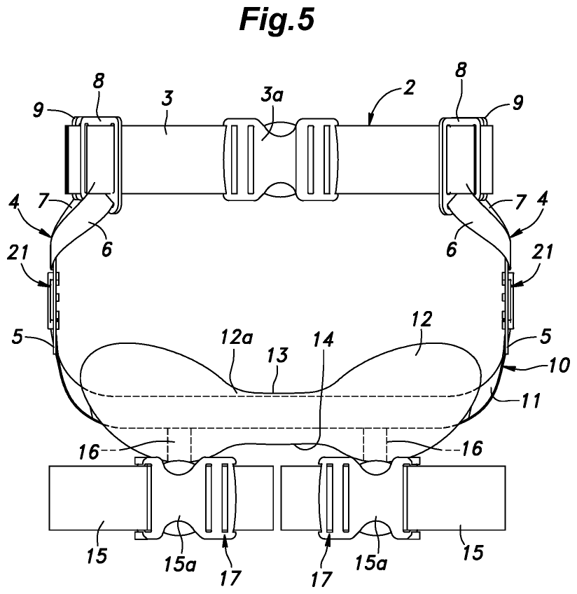

Particularly, as shown in FIGS. 2 and 5, the buttocks pad 12 is provided at the laterally central portion thereof with the low stiffness part 12a having low torsional stiffness compared to the left and right side portions. Therefore, at the time of walking in which the left and right legs are moved in the fore and aft direction at different phases, the buttocks pad 12 undergoes torsional deformation in response to twisting of the buttocks that accompanies the motion of the lower limbs. Thereby, positional shift of the buttocks pad 12 relative to the buttocks is favorably prevented.

Note that the buttocks pad 12 is provided at the laterally central portion thereof with a narrow part formed by the upper cutout 13 and the lower cutout 14 and this narrow part serves as the low stiffness part 12a. By thus forming the low stiffness part 12a by the shape of the narrow part, it is possible to manufacture the buttocks pad 12 having the low stiffness part 12a without varying the thickness of the material or using materials with different bending strengths in combination, which allows easy manufacture of the buttocks pad 12.

In this way, in such cases as when the user P sits on a chair or the like or squats in a Hindu squat motion or the like, the bending and stretching motion assist device 1 realizes, without requiring an actuator such as an electric motor, the function of generating an assist force in the direction to stretch the both legs once the bending degrees of the both legs become greater than or equal to a certain degree when the both legs are bent to a relatively large bending degree while, on the other hand, substantially not generating the aforementioned assist force when the bending degrees of the both legs are small.

In addition, the bending and stretching motion assist device 1 is configured such that the motion transmission by the motion transmission mechanism 40 is carried out by using the wire 41, and therefore, the bending and stretching motion assist device 1 is lightweight and simple in structure. Specifically, the assist force generation device is realized as a simple and lightweight configuration by including the wire 41, which is a flexible elongated member, the left and right pulleys 26 functioning as cam members for changing the route length of the wire 41, and the spring members 30 configured to expand and contract in response to the change in the route length of the wire 41. Thereby, the user P can perform walking motion or the like while wearing the bending and stretching motion assist device 1, in the same manner as usual without feeling discomfort or burden.

As shown in FIGS. 1 and 4, in the present embodiment, the left and right thigh links 22 are detachably coupled to the torso mount member 2 via the respective attachment and detachment mechanisms 21, and therefore, the left and right leg link mechanisms 20 can be removed from and attached to the torso mount member 2 with the torso mount member 2 being worn on the torso of the user P. This facilitates wearing and removal of the bending and stretching motion assist device 1 (ease of wearing improves). In addition, since attachment and detachment of only the leg link mechanisms 20 is possible, the usability of the bending and stretching motion assist device 1 improves.

Also, as shown in FIG. 8, the assist force acting on the torso of the user P is transmitted from the buttocks support member 10 to the buttocks of the user P, and therefore, the torso mount member 2 can be configured to have the annular torso belt 3 to be worn on the torso of the user P and the left and right link support members 4 provided to depend from the left and right side portions of the torso belt 3. In this way, because the torso mount member 2 is constituted of the torso belt 3, the torso mount member 2 can have a simple and lightweight configuration and the weight of the bending and stretching motion assist device 1 is reduced. Also, since the buttocks support member 10 transmits the load of the upper body of the user P to the thigh links 22, it is possible to provide the left and right link support members 4 to depend from the side portions of the torso belt 3, and this also contributes to allowing the torso mount member 2 to have a simple and lightweight configuration.

Furthermore, in the present embodiment, each link support member 4 includes the support plate 5 having high stiffness and swingably supporting the upper end of the thigh link 22 on the corresponding side and the front suspension belt 6 and the rear suspension belt 7, which serve as a flexible belt member, coupling the support plate 5 to the torso belt 3. Therefore, the left and right support plates 5 are not rigidly joined to each other, and the buttocks support member 10 extending between the left and right support plates 5 supports the buttocks like a hammock, whereby a pressure making the left and right support plates 5 closely contact the torso side portions (hip side portions) is generated according to the force supporting the buttocks. Namely, the pressure is always adjusted to an appropriate pressure that prevents positional shift of the support plates 5, and therefore, fitting property is improved. Also, when the buttocks support member 10 is not generating the force supporting the buttocks, unnecessary pressure is not generated between each support plate 5 and the torso side portion (hip side portion). Further, it is possible to reduce the size of the support plate 5, to thereby reduce the weight of the link support member 4.

Also, the front suspension belt 6 extends obliquely forward and upward from the front portion of the support plate 5 to be joined to the torso belt 3, and the rear suspension belt 7 extends obliquely rearward and upward from the rear portion of the support plate 5 to be joined to the torso belt 3. Thus, the support plate 5 is joined to the torso belt 3 so as not to move in the fore and aft direction.

As shown in FIG. 3, in the present embodiment, each end portion of the buttocks support member 10 is coupled to the support plate 5 on an extension line of the front suspension belt 6, whereby the support plate 5 is prevented from easily shifting from an appropriate position. Specifically, when an assist force is generated between the thigh link 22 and the lower leg link 23, the link mechanism configure by the thigh link 22 and the lower leg link 23 generates force for pushing up the support plate 5, while the buttocks support member 10 generates force pulling the support plate 5 in the downward and rearward direction. The net force obtained from these forces urges the support plate 5 to move rearward. The front suspension belt 6 restrains this movement and holds the support plate 5 at an appropriate position.

As shown in FIGS. 3 and 8, each end portion of the buttocks support member 10 is joined to the link support member 4, and the left and right thigh belts 15 which are annular in shape to be worn on the left and right thighs of the user P are coupled to the buttocks support member 10 by the left and right coupling bands 16, respectively. Thereby, the thigh belts 15 prevent the buttocks support member 10 from shifting upward relative to the buttocks.

Further, because the left and right thigh belts 15 are each provided in a non-coupling manner with the thigh link 22 on the corresponding side, it is possible to prevent positional shift of the buttocks support member 10 due to movement of the thigh belts 15 in response to motion of thigh links 22.

### Second Embodiment

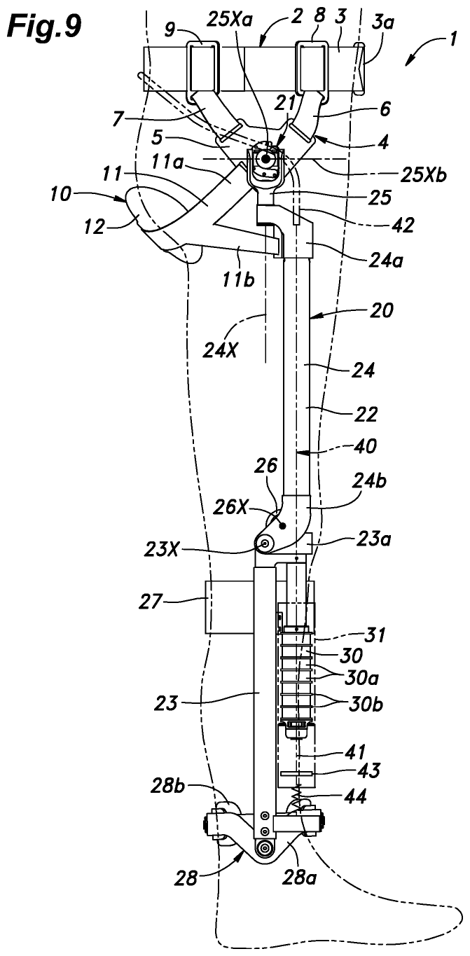

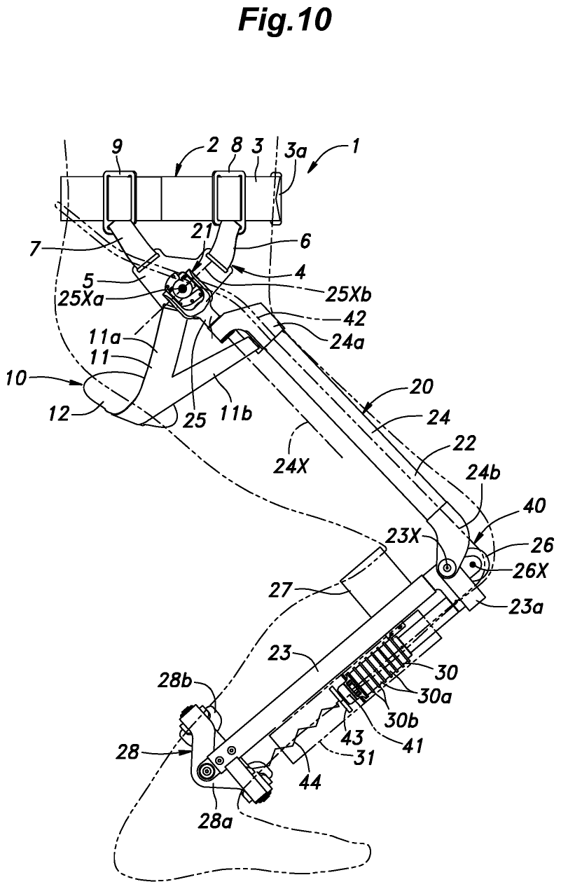

Next, with reference to FIG. 9 and FIG. 10, the second embodiment of the present invention will be described. Note that the elements identical to those in the first embodiment are denoted by the same reference numerals, and redundant description will be omitted.

The bending and stretching motion assist device 1 of this embodiment differs from the first embodiment in that the left and right thigh belts 15 and left and right coupling bands 16 of the first embodiment are not provided, and the shape and the supporting manner of the buttocks belt 11 is different. Specifically, the buttocks belt 11 has ends each bifurcated into upper and lower parts on a lateral side of the buttocks pad 12. The upper part (hereinafter referred to as the end upper part 11a) of each end portion of the buttocks belt 11 is joined to the rear portion of the support plate 5, as in the first embodiment. The lower part (hereinafter referred to as the end lower part 11b) of each end portion of the buttocks belt 11 is joined to the thigh link 22 of the leg link mechanism 20 on the corresponding side. Specifically, the end lower part 11b of the buttocks belt 11 is joined to the upper end portion 24a of the link main body 24.

In this embodiment also, when the user P wearing the bending and stretching motion assist device 1 bends the both legs by approximately the same bending degree from the state in which the both legs are stretched, an assist torque in the stretching direction acts on each leg link mechanism 20, as shown in FIG. 10. At this time, the left and right end lower parts 11b of the buttocks belt 11 are pulled forward by the thigh links 22, and the buttocks pad 12 moves forward to be positioned lower than the upper ends of the thigh links 22. Therefore, the upward force transmitted from each link support member 4 of the torso mount member 2 to the torso of the user P is transmitted from the link support member 4 to the buttocks support member 10 and then from the buttocks pad 12 positioned below the buttocks to the buttocks of the user P.

In this way, in the present embodiment, each end portion of the buttocks support member 10 is coupled to a part of the thigh link 22 which is closer to the lower leg link 23 than the laterally extending swing axis 25Xa, which is a connecting part with the torso mount member 2, whereby the buttocks support member 10 remains below the buttocks of the user P and reliably supports the load of the buttocks.

### Third Embodiment

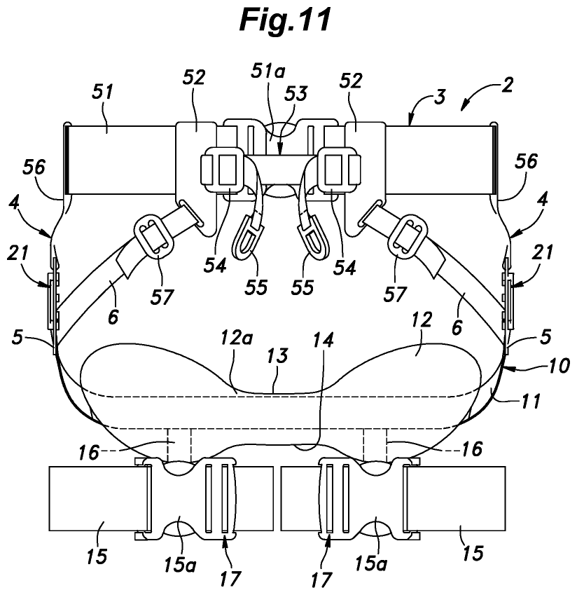

With reference to FIGS. 11 to 13, the third embodiment of the present invention will be described. Note that the elements identical to those in the first embodiment are denoted by the same reference numerals, and redundant description will be omitted.

The bending and stretching motion assist device 1 of this embodiment differs from the first embodiment with respect to the configuration of the torso mount member 2. In the following, description will be made concretely. The torso mount member 2 includes an annular torso belt 3 and is worn on the waist of the user P with the torso belt 3 wound around the waist. The torso belt 3 includes a strip-shaped belt main part 51 and a coupling belt 53 configured to be disposed on the front side of the abdomen of the user P and coupling two end members 52 provided at respective ends of the strip-shaped belt main part 51. Instead of the above-described buckle 3a provided to be disposed on the front side, the belt main part 51 is provided at a lengthwise intermediate portion thereof with a rear buckle 51a to be disposed on the back of the waist of the user P.

Each end member 52 is formed with a claw for engaging with the coupling belt 53, and thus the coupling belt 53 is detachable from the belt main part 51. The coupling belt 53 is provided at a lengthwise intermediate portion thereof with two engagement devices 54 to be engaged by the claws of the end members 52 of the torso belt 3 and also is provided with two grips 55 at the respective ends. Each engagement device 54 is provided with a length adjustment mechanism and is coupled to the belt main body of the coupling belt 53 via the length adjustment mechanism. By pulling at least one of the two grips 55, it is possible to shorten the length of the coupling belt 53 between the two engagement devices 54. Namely, the coupling belt 53 constitutes a front length adjustment mechanism capable of adjusting the length of the front part of the torso belt 3.

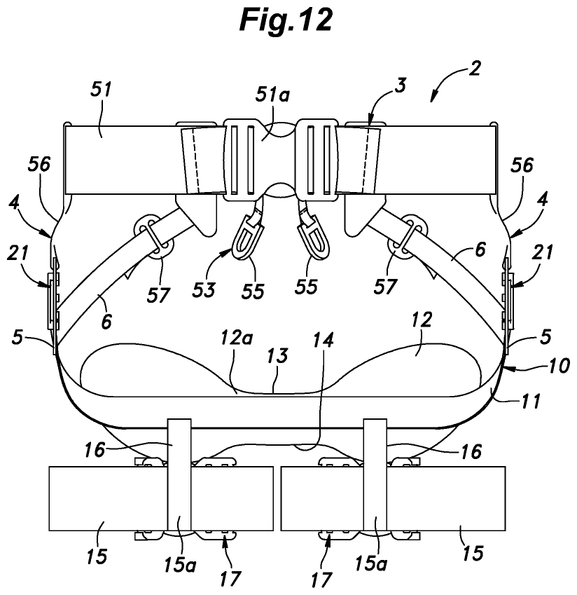

As shown in FIG. 12, the rear buckle 51a is constituted of two buckle members that can be separated to the left and right, and each buckle member is coupled to left and right belt main bodies of belt main part 51 in a length adjustable manner. By pulling at least one of the excess parts of the left and right belt main bodies, it is possible to shorten the length of the belt main part 51. Namely, the rear buckle 51a constitutes a rear length adjustment mechanism capable of adjusting the length of the rear part of the torso belt 3.

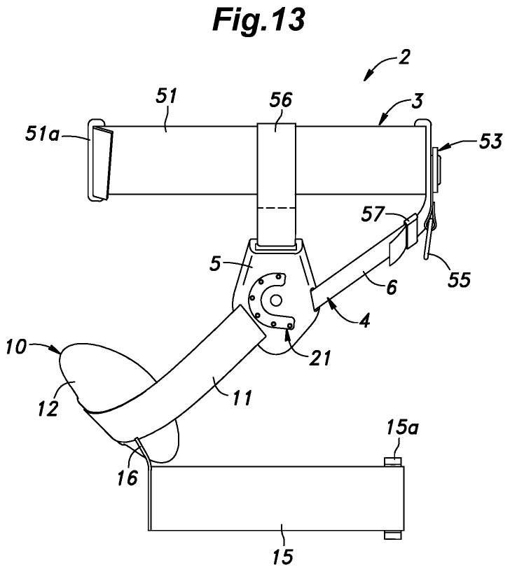

As shown in FIG. 13, the torso mount member 2 further includes left and right link support members 4 swingably supporting the upper ends of the left and right leg link mechanisms 20 on the lateral sides of the left and right hip joints of the user P, respectively. Each link support member 4 includes a support plate 5 having high stiffness and swingably supporting the upper end of the leg link mechanism 20 (see FIG. 3) on the corresponding side and a main suspension belt 56 which is a belt member extending upward from the upper portion of the support plate 5 and is coupled to the torso belt 3. The main suspension belt 56 is joined to the torso belt 3 to be slidable in the circumferential direction. Namely, each link support member 4 is provided on the corresponding left or right side portion of the torso belt 3 to be slidable in the circumferential direction relative to the torso belt 3. Also, each link support member 4 further includes a front suspension belt 6 extending obliquely forward and upward from the front portion of the support plate 5 and joined to the torso belt 3.

Each support plate 5 has a substantially pentagonal shape which is more vertically elongated than the first embodiment, and is coupled to the torso belt 3 via the main suspension belt 56 and the front suspension belt 6. The front suspension belt 6 is provided with a length adjustment device 57 and thereby couples the support plate 5 and the end member 52 of the torso belt 3 such that the length can be adjusted according to the circumferential position of the main suspension belt 56.

Thus, in the present embodiment, the main suspension belt 56 is provided to be slidable relative to the torso belt 3 in the circumferential direction. Therefore, the position of the support plate 5 in the circumferential direction can be changed easily.

Also, in the present embodiment, the torso belt 3 is provided with the coupling belt 53 constituting a front length adjustment mechanism capable of adjusting the length of the front part between the left and right link support members 4 and the rear buckle 51a constituting a rear length adjustment mechanism capable of adjusting the length of the rear part. Therefore, even when the torso mount member 2 is worn on the torso of the user P, the positions of the left and right link support members 4 in the circumferential direction can be adjusted by adjusting the length of the torso belt 3 with the length adjustment mechanism including the coupling belt 53 and the rear buckle 51a. Therefore, the bending and stretching motion assist device 1 with excellent fitting property which can be suited to the physique of the user P can be provided.

### Fourth Embodiment

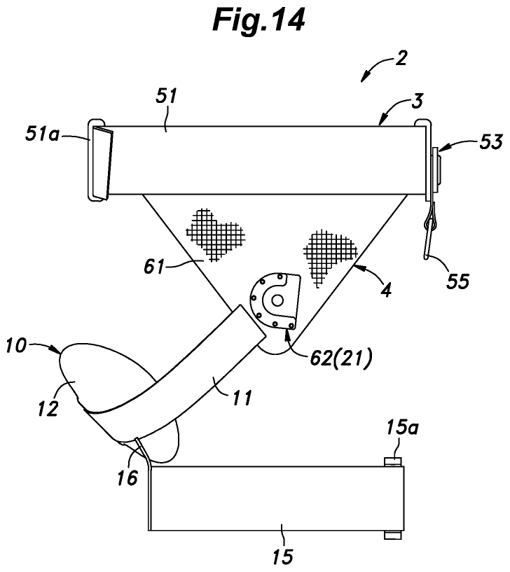

With reference to FIG. 14, the fourth embodiment of the present invention will be described. Note that the elements identical to those in the first and third embodiments are denoted by the same reference numerals, and redundant description will be omitted.

In the bending and stretching motion assist device 1 of this embodiment, the configuration of the left and right link support members 4 differs from the third embodiment. Specifically, each link support member 4 includes a substantially inverted-triangular flexible member 61 having flexibility and depending from a side portion of the torso belt 3 and a joint member 62 provided adjacent to the lower end of the flexible member 61 and swingably supporting the upper end of the thigh link 22 (see FIGS. 1 to 3) on the corresponding side. The joint member 62 cooperates with the upper coupling member 25 of the leg link mechanism 20 (see FIG. 3) to configure the attachment and detachment mechanism 21. Note that the flexible member 61 is only required to have an upper side with a width greater than that of the lower side, and is not limited to an inverted triangular shape but may be in an inverted trapezoidal shape. The buttocks belt 11 of the buttocks support member 10 is joined to a lower portion of the flexible member 61 by suture.

In this way, the joint member 62 is provided adjacent to the lower end of the substantially inverted-triangular flexible member 61, and therefore, the load of the link support member 4 is transmitted to a circumferentially elongated part of the torso belt 3 in a dispersed manner. Therefore, the weight of the bending and stretching motion assist device 1 felt by the user P when wearing the device is reduced.

Concrete embodiments have been described in the foregoing, but the present invention is not limited to the above embodiments and may be modified or altered in various ways. For example, the bending and stretching motion assist device 1 may include the left and right thigh belts 15 and the left and right coupling bands 16 of the first embodiment and the structure of the buttocks belt 11 of the second embodiment. Further, in the above embodiments, the buttocks belt 11 is constituted of a single belt member passing the rear side of the buttocks pad 12, but the buttocks belt 11 may be constituted of two belt members each coupling one of the left and right end portions of the buttocks pad 12 to a part adjacent to the connecting part of the leg link mechanism 20 and the torso mount member 2 on the corresponding side. Also, the low stiffness part 12a of the buttocks pad 12 is given low stiffness due to the upper cutout 13 and the lower cutout 14 formed in the upper and lower sides of the buttocks pad 12, namely, due to the contour shape of the buttocks pad 12, but may be given low stiffness by varying the thickness of the material or by using materials with different bending strengths in combination. Furthermore, in the above embodiments, the spring member 30 is provided for each of the left and right lower leg links 23, but the position and the number of the spring members 30 are not limited to this. For example, the spring member 30 may be provided in one of the left and right lower leg links 23 or may be provided in one or both of the left and right thigh links 22. Alternatively, the spring member 30 may be provided on the torso mount member 2. Besides, the concrete structure, arrangement, number, etc. of each member or part may be appropriately changed without departing from the spirit of the present invention. On the other hand, not all of the components shown in the above embodiments are necessarily indispensable and they may be selectively adopted as appropriate.

### LIST OF REFERENCE NUMERALS

1 bending and stretching motion assist device
2 torso mount member
3 torso belt
4 link support member (part adjacent to the swing axis 25Xa)
5 support plate
6 front suspension belt (belt member)
7 rear suspension belt (belt member)
10 buttocks support member
11 buttocks belt
12 buttocks pad
12a low stiffness part
13 upper cutout (narrow part)
lower cutout (narrow part)
15 thigh belt
20 leg link mechanism
22 thigh link
23 lower leg link
24 link main body of thigh link 22
24a upper end portion (part adjacent to the swing axis 25Xa)
25 upper coupling member (upper end of the thigh link 22)
25Xa laterally extending swing axis (connecting part between the thigh
link 22 and the torso mount member 2)
26 pulley (cam member)
27 knee belt (knee mount member)
28 lower leg mount member
30 spring member (assist force generation device)
40 motion transmission mechanism (assist force generation device)
41 wire (elongated member)
51a rear buckle (rear length adjustment mechanism)
53 coupling belt (front length adjustment mechanism)
56 main suspension belt (belt member)
61 flexible member
62 joint member
P user

1. A bending and stretching motion assist device, comprising:
left and right thigh links configured to be respectively disposed along left and right thighs of a user;
left and right lower leg links configured to be respectively disposed along left and right lower legs of the user and swingably coupled to lower ends of the corresponding thigh links;
a torso mount member having an annular shape to be able to be worn on a torso of the user and to support upper ends of the left and right thigh links swingably on respective sides of left and right hip joints of the user;
left and right lower leg mount members respectively attached to lower ends of the left and right lower leg links so as to be able to be worn on the corresponding lower legs of the user;
an assist force generation device configured to generate assist force in a stretching direction between the lower leg links and the thigh links to assist bending and stretching motion of lower limbs of the user; and
a buttocks support member extending between parts of the torso mount member adjacent to connecting parts of the torso mount member that connect the torso mount member to the left and right thigh links, respectively, or between parts of the left and right thigh links adjacent to connecting parts of the left and right thigh links that connect the left and right thigh links to the torso mount member, respectively, thereby configured to be disposed along buttocks of the user.

2. The bending and stretching motion assist device according to claim 1, wherein the torso mount member includes an annular torso belt configured to be worn on the torso of the user, and left and right link support members provided to depend from left and right side portions of the torso belt and supporting the upper ends of the left and right thigh links.

3. The bending and stretching motion assist device according to claim 2, wherein each link support member includes a support plate having high stiffness and swingably supporting the upper end of the thigh link on a corresponding side and a flexible belt member coupling the support plate to the torso belt.

4. The bending and stretching motion assist device according to claim 3, wherein the belt member includes a front suspension belt extending obliquely forward and upward from a front portion of the support plate and joined to the torso belt and a rear suspension belt extending obliquely rearward and upward from a rear portion of the support plate and joined to the torso belt.

5. The bending and stretching motion assist device according to claim 4, wherein each end portion of the buttocks support member is coupled to the support plate on an extension line of the front suspension belt.

6. The bending and stretching motion assist device according to claim 3, wherein the belt member is provided to be slidable relative to the torso belt in a circumferential direction.

7. The bending and stretching motion assist device according to claim 2, wherein each link support member includes a substantially inverted-triangular flexible member having flexibility and depending from a side portion of the torso belt and a joint member provided adjacent to a lower end of the flexible member and swingably supporting the upper end of the thigh link on a corresponding side.

8. The bending and stretching motion assist device according to claim 2, wherein the torso belt is provided with a front length adjustment mechanism and a rear length adjustment mechanism capable of adjusting lengths of a front part and a rear part between the left and right link support members.

9. The bending and stretching motion assist device according to claim 2, wherein each end portion of the buttocks support member is joined to the link support member, and
wherein the bending and stretching motion assist device further comprises left and right thigh belts which are annular in shape to be worn on the left and right thighs of the user, respectively, and are coupled to the buttocks support member.

10. The bending and stretching motion assist device according to claim 9, wherein the left and right thigh belts are each provided in a non-coupled manner with the thigh link on a corresponding side.

11. The bending and stretching motion assist device according to claim 1, wherein each end portion of the buttocks support member is coupled to a part of the thigh link which is closer to the lower leg link than the connecting part with the torso mount member.

12. The bending and stretching motion assist device according to claim 1, further comprising left and right knee mount members provided on lower portions of the left and right thigh links or upper portions of the lower leg links to be worn on parts of the user adjacent to knee joints of the left and right lower limbs, respectively.

13. The bending and stretching motion assist device according to claim 1, wherein the buttocks support member includes a buttocks pad positioned lower than the upper ends of the thigh links in a bent state of the lower limbs of the user.

14. The bending and stretching motion assist device according to claim 13, wherein the buttocks pad is provided at a laterally central portion thereof with a low stiffness part having a torsional stiffness lower than that of left and right side portions.

15. The bending and stretching motion assist device according to claim 13, wherein the buttocks pad has a narrow part at a laterally central portion thereof.

16. The bending and stretching motion assist device according to claim 1, wherein the left and right thigh links are each detachably coupled to the torso mount member via an attachment and detachment mechanism.

17. The bending and stretching motion assist device according to claim 1, wherein the assist force generation device includes a flexible elongated member, left and right cam members configured to change a route of the elongated member such that a route length becomes longer as a total value of swing angles of the left and right thigh links relative to the left and right lower leg links increases, and a spring member configured to expand and contract in response to a change in the route length of the elongated member.
